(19) United States
(12) Patent Application Publication
(10) Pub. No.: US 2011/0098950 A1
(43) Pub. Date: Apr. 28, 2011

(54) Infrasound Sensor

(75) Inventor: Dustin Wade Carr, Albuquerque, NM (US)

(73) Assignee: SYMPHONY ACOUSTICS, INC., Rio Rancho, NM (US)

(21) Appl. No.: 12/913,620

(22) Filed: Oct. 27, 2010

Related U.S. Application Data
(60) Provisional application No. 61/255,663, filed on Oct. 28, 2009.

(51) Int. Cl. G06F 15/00

(52) U.S. Cl. 702/56

(57) ABSTRACT

Embodiments of infrasound sensors comprising multiple matched-responsivity pressure sensors are presented. Infrasound sensors in accordance with the present invention have limited volume, which enables them to observe wind velocity at the same point that infrasound is monitored. The small size and matched-responsivities enable infrasound sensors in accordance with the present invention to obviate the need for complex and costly spatial filters that degrade the signal-to-noise ratio of prior-art infrasound sensors.

### CROSS-REFERENCE TO RELATED APPLICATION

This application claims the benefit of U.S. provisional application Ser. No. 61/255,663, filed Oct. 28, 2009, entitled “Infrasound Sensor,” (Attorney Docket: 123-140us), which is incorporated by reference.

### FIELD OF THE INVENTION

The present invention relates to displacement sensors in general, and, more particularly, to infrasound sensors.

### BACKGROUND OF THE INVENTION

Infrasound is sonic energy characterized by a frequency lower than the range of human hearing (i.e., less than approximately 20 Hz). Infrasound manifests as pressure waves having wavelengths that are kilometers to hundreds of kilometers. As a result, infrasound can propagate over extremely long distances—even around the globe. Detection of infrasound, therefore, can provide useful information about geophysical phenomena such as avalanches, earthquakes, tsunami, and volcanic eruptions. Infrasound detection also forms the basis of much of the international network that monitors nuclear explosions for the purpose of test ban treaty enforcement.

Conventional infrasound sensing systems typically comprise an array of inlets arranged about a relatively bulky microbarometer contained in a housing. The inlets are connected to an opening at the top of the housing to fluidically couple the inlets to the diaphragm of the microbarometer. The diaphragm divides the housing into a front (i.e., top) chamber and a back chamber. The diaphragm vibrates with pressure disturbances in the air, much like a conventional audio microphone, thereby providing an output signal based on the pressure at the inlets.

The response time of the infrasound sensor is based on how fast pressure equalizes between the front and back chambers. A small capillary tube is typically used to fluidically couple the front and back chambers so as to provide a “leak” between them. The time constant for the equalization of the pressures in the front and back chambers is based on the size of this capillary tube.

To date, it has been difficult, if not impossible, to differentiate pressure changes due to wind from infrasound energy. Wind interferes with infrasound sensing because it produces an additional pressure fluctuation that cannot be easily discerned from infrasound signals significantly degrading the signal-to-noise ratio of the detection system. To mitigate the effects of wind-induced noise, the inlets of the infrasound sensor are typically connected with the housing through a complex arrangement of inlet hoses. The hose configuration works as a spatial filter for wind noise. In operation, this mechanical spatial filter samples the atmosphere at a series of points spaced around the microbarometer. The pressure signals from these points are mechanically added at the union of the plurality of tubes at the single microbarometer.

While these hose arrangements are somewhat effective in reducing wind noise, they present many other challenges. Phase delays along the lengths of the pipes arise due to finite sound velocity. This limits the size of the area of the mechanical filters over which response can be averaged. Further, because of the size of these spatial filters there is no practical way of measuring their response. Still further, the complexity of the installation is substantial and the deployment of such a sensor in remote locations can be extremely challenging. Hard-walled pipes, such as PVC or metal pipes, produce undesirable resonance affects. As a result, porous garden houses, such as those that can be bought at a local retail store, are normally used. The quality control for such hoses is virtually non-existent. In addition, their actual porosity to air in real conditions has not been evaluated in a scientific manner. Although the use of garden hoses mitigates the problem of resonance effects, it is not clear what additional problems are being introduced by their use in this manner.

### SUMMARY OF THE INVENTION

The present invention provides an infrasound sensor that overcomes some of the disadvantages of the prior art. Embodiments of the present invention are particularly well suited for detecting explosions; avalanches; earthquakes; severe weather; shock waves due to meteor strikes and supersonic jets; variations in local magnetic field strength during auroral displays; and microbaroms related to kilometer size standing waves on the ocean.

In some embodiments, an array of pressure ports is symmetrically arranged about a central point. The pressure ports are located within a small volume such that they are substantially uniformly affected equally by infrasound energy. Each of the pressure ports is fluidically coupled with a pressure sensor comprising a displacement sensor having very high sensitivity and very small footprint. Each displacement sensor is based on an optical beam splitter that distributes the optical energy of an input beam into a reflected beam and a transmitted beam. A processor receives output signals based on each of these reflected and transmitted beams. The compactness of the infrasound sensor enables it to observe wind velocity and infrasound at substantially the same point.

It is an aspect of the present invention that the beam-splitter-based pressure sensors have substantially matched responsivities. The matched responsivities, coupled with the small volume of the sensor, enable differences in the output signals of the pressure sensors to be attributed to affects of wind noise. Wind noise, therefore, can be directly cancelled. This obviates the need for complicated hose-based spatial filters and/or isolation vaults typically required for prior-art infrasound sensing systems. As a result, embodiments of the present invention are significantly cheaper and less complex than prior-art infrasound sensing systems. Further, embodiments of the present invention can have improved sensitivity as compared to prior-art infrasound sensors.

An embodiment of the present invention comprises an apparatus for sensing infrasound energy, wherein the apparatus comprises: a plurality of pressure sensors symmetrically arranged about an origin, each pressure sensor comprising: (a) a pressure port; and (b) a displacement sensor fluidically coupled with the pressure port, the displacement sensor comprising a beam splitter that distributes an input signal into a first signal and a second signal based on a pressure at the pressure port, wherein the displacement sensor is dimensioned and arranged to provide a pressure signal that is based on at least one of the first signal and the second signal; wherein the responsivity of each of the plurality of pressure sensors is within ±2.5% of the average responsivity of the plurality of pressure sensors.

### BRIEF DESCRIPTION OF THE DRAWINGS

FIG. 1 depicts a schematic diagram of a cross-section of an infrasound sensor in accordance with the prior art.

FIG. 2 depicts an infrasound measurement installation in accordance with an illustrative embodiment of the present invention.

FIG. 3 depicts operations of a method for sensing infrasound in accordance with the illustrative embodiment of the present invention.

FIG. 4 depicts a schematic drawing of a cross-sectional view of an infrasound sensor in accordance with the illustrative embodiment of the present invention.

FIG. 5 depicts a schematic diagram of a pressure sensor in accordance with the illustrative embodiment of the present invention.

FIGS. 6A and 6B depict top and cross-sectional views, respectively, of a beam splitter in accordance with the illustrative embodiment of the present invention.

FIG. 7 depicts a model of pressure versus position for a stationary object subjected to wind.

FIG. 8 depicts the velocity distribution associated with wind incident on a stationary object.

FIGS. 9A and 9B depict top and cross-sectional views, respectively, of a beam splitter in accordance with an alternative embodiment of the present invention.

### DETAILED DESCRIPTION

The following terms are defined for use in this Specification, including the appended claims:
Operatively Coupled is defined as a condition wherein a first object, which might be remote from a second object, affects the second object or has some effect on a third object through the second object, etc. For example, consider a rigid linkage having a first end and a second end. The first end attaches to a plate and the second end abuts a wall. The linkage is capable of transferring, to the wall, a force that is received at the plate. The linkage and the plate can therefore be considered to be operatively coupled for transmitting a force. Operatively-coupled objects need not be in direct contact with one another and, as appropriate, can be coupled through any medium (e.g., semiconductor, air, vacuum, water, copper, optical fiber, etc.). The coupling between operatively-coupled objects can transmit, as appropriate for the nature of the coupling and the objects, any type of force, signal, charge, electrical current, optical energy, etc. Consequently, operatively-coupled objects can be electrically-coupled, hydraulically-coupled, magnetically-coupled, mechanically-coupled, optically-coupled, pneumatically-coupled, thermally-coupled, fluidically-coupled, etc.
Fluidically Coupled is defined as that, with respect to two regions, fluid (i.e., liquid, vapor, gas) can move between the two regions or that a change in pressure in one region can affect the pressure in the other region, etc.

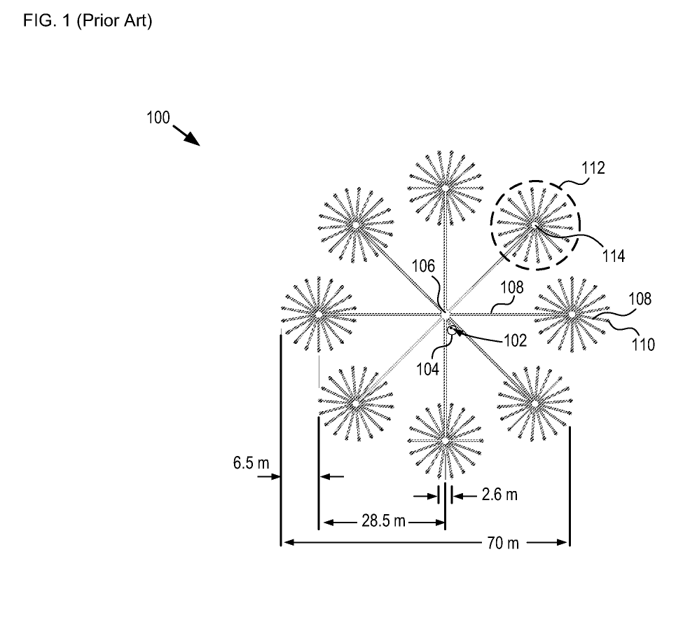

FIG. 1 depicts a schematic diagram of a cross-section of an infrasound sensor in accordance with the prior art. Sensor 100 comprises barometer 102, chamber 104, manifold 106, conduits 108, and inlets 110. Prior-art examples of infrasound sensors such as sensor 100 include two- and three-dimensional configurations.

Barometer 102 is a pressure sensor that is contained within chamber 104, which is fluidically coupled with manifold 106.

Manifold 106 is fluidically coupled with each of the plurality of inlets 110 through conduits 108.

Conduits 108 are conduits that fluidically couple inlets 110 and manifold 106 (and, therefore, barometer 102).

Wind interferes with infrasound sensing by producing pressure fluctuations that cannot be easily discerned from infrasound energy. As a result, wind represents a noise source that can devastate the performance of a conventional infrasound sensor. In order to provide a spatial filter for wind, inlets 110 are arrayed, substantially symmetrically, about manifold 106. In many common arrangements, inlets 110 are arranged in symmetric clusters 112, which are symmetrically arranged about secondary manifolds 114, which are further arranged symmetrically about manifold 106.

Since it is desirable to deploy infrasound sensors throughout the world, these systems are often deployed in remote areas such as tropical rainforests, arid deserts, mountainous regions, and the like. Further, wind noise rejection is dependent upon the relative separation between inlets 110; therefore, their positions relative to one another, as well as manifold 106, are critical. Still further, wind noise rejection improves as the relatively separations of inlets 110 increases. Sensor 100, for example, is characterized by inlet separations that range from a few meters to nearly 100 meters. As a result, the installation complexity of arrangements such as that of sensor 100 is quite substantial and the deployment of such a sensor in remote locations can be challenging.

In addition to the challenges associated with deploying system 100, the choice of material for conduits 108 present further issues. Using hard-walled conduits, such as PVC or steel pipes, for conduits 108 can result in undesirable resonances in the output signal of barometer 102; therefore, porous conduits are more desirable. Due to its porosity and ready availability world-wide, the most common choice for conduits 108 is the common garden hose. The use of garden hoses to fluidically couple inlets 110 and barometer 102 presents many other challenges, however.

First, the quality control of the garden hose is not rigorous since, for most applications, it is simply not important.

Second, the actual porosity to air in real conditions has not been evaluated in any scientific manner.

Third, the reliability and life time of the common garden hose is dramatically affected by the environmental conditions in which it is deployed. Reliability and lifetime are severely degraded when the hoses are exposed to the harsh conditions inherent to tropical or sub-tropical rainforests or arid desert regions. Plasticizer in the hose walls outgases over time, making a garden hose more brittle. Hose material degrades due to exposure to sunlight, extreme temperatures, and the like. Animal attack (e.g., mouse bites, etc.) or animals nesting within the hoses are commonly reported. These practical considerations significantly reduce the desirability of the use of garden hoses in an infrasound installation.

The present invention enables measurement of infrasound without the need for large-area arrays of sensors that are interconnected by conduits. Embodiments of the present invention utilize a small-area array of sensors having well-matched responsivities to observe wind velocity and monitor infrasound signals at the substantially same point. Because their responsivities are well matched, disparities between the outputs of different sensors can be directly attributed to wind-induced pressure fluctuations and, therefore, readily cancelled.

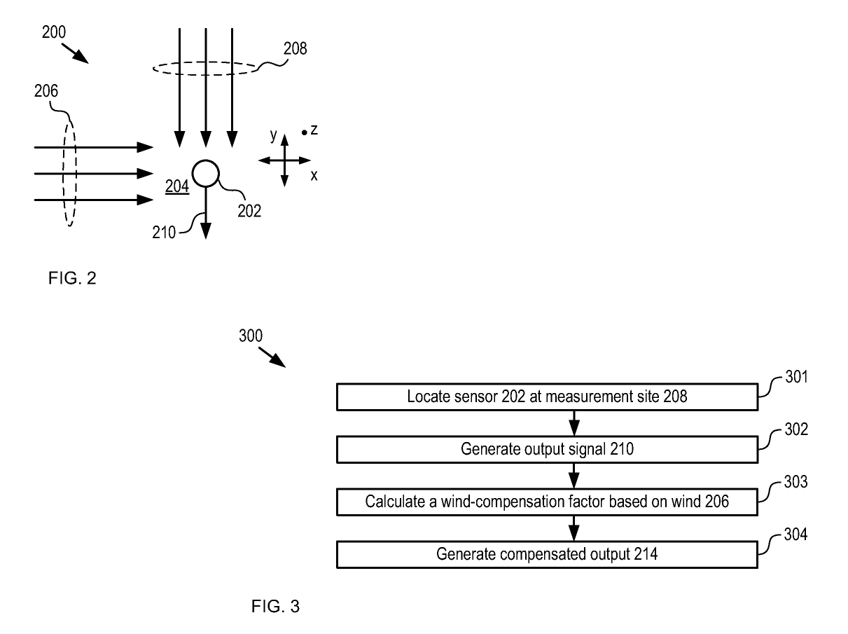

FIG. 2 depicts an infrasound measurement installation in accordance with an illustrative embodiment of the present invention. Infrasound measurement installation 200 comprises sensor 202, which is deployed at measurement site 204.

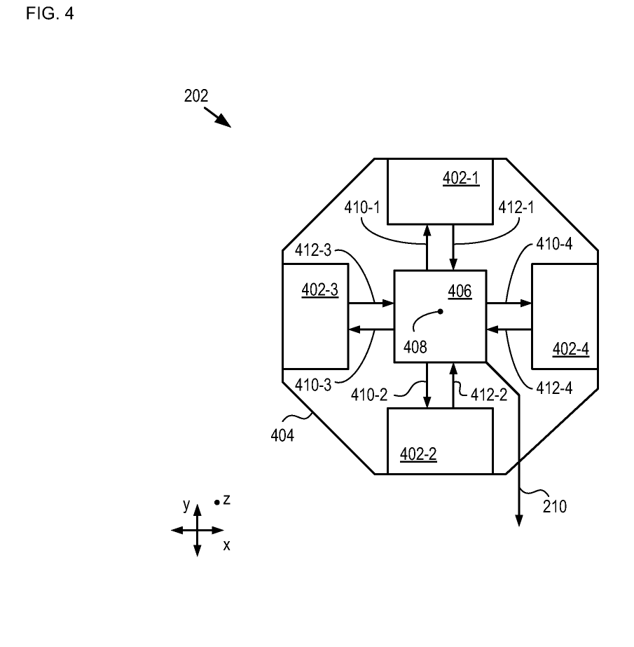

Sensor 202 is an infrasound detector that provides output signal 210. Sensor 202 mitigates the effects due to wind at measurement site 204, which results in a higher signal-to-noise ratio output for infrasound. Sensor 202 is described in more detail below and with respect to FIG. 4.

FIG. 3 depicts operations of a method for sensing infrasound in accordance with the illustrative embodiment of the present invention. Method 300 begins with operation 301, wherein sensor 202 is deployed at measurement site 204.

FIG. 4 depicts a schematic drawing of a cross-sectional view of an infrasound sensor in accordance with the illustrative embodiment of the present invention. Sensor 202 comprises pressure sensors 402-1 through 402-6, housing 404, and processor 406.

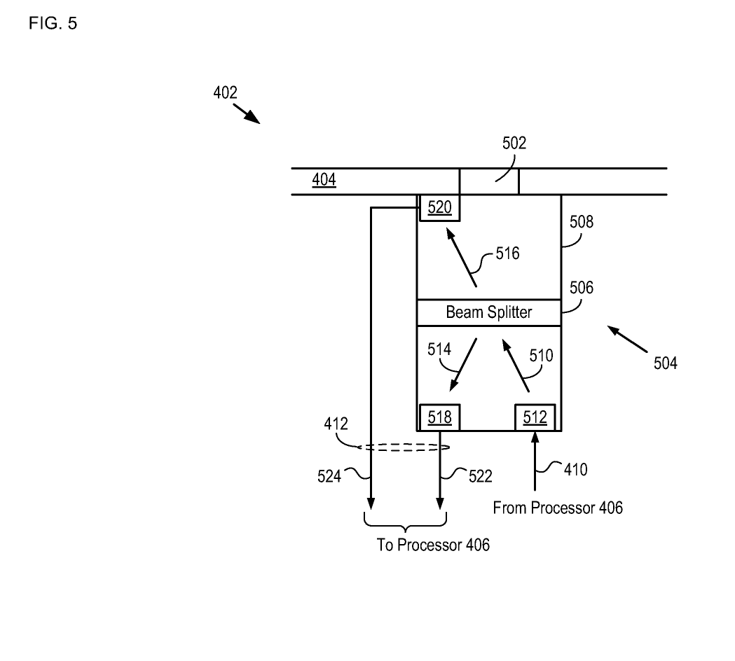

Each of pressure sensors 402-1 through 402-6 (collectively referred to as pressure sensors 402) comprises a displacement sensor that is fluidically coupled with a pressure port. Pressure sensors 402 are described in more detail below and with respect to FIG. 5.

Housing 404 is a substantially rigid, three-dimensional, substantially spherical housing that locates pressure sensors 402. Housing 404 positions each pressure sensor 402 such that its respective pressure port is located in the center of a different face of a substantially symmetric cube centered at origin 408. Pressure sensors 402-1 and 402-2 are displaced from one another along the y-direction. Pressure sensors 402-3 and 402-4 are displaced from one another along the x-direction. Pressure sensors 402-5 and 402-6 (not shown for clarity) are displaced from one another along the z-direction.

In some embodiments, housing 404 is non-spherical. Although the illustrative embodiment comprises six displacement sensor/pressure port assemblies, it will be clear to one skilled in the art, after reading this specification, how to specify, make, and use alternative embodiments of the present invention that comprise any number of displacement sensor/pressure port assemblies. It is preferable, although not required, that the pressure ports be substantially equidistant about origin 408. Preferable three-dimensional arrangements include, therefore, sensors that comprise platonic polyhedrons having 6, 8, 12, 20 . . . etc. sides. In some embodiments, the pressure ports are arranged in non-three-dimensionally symmetric arrangements such as toroid, or other shape.

Processor 406 is a general purpose processor that is suitable for providing control signals 410 to pressure sensors 402, receiving pressure signals 412-1 through 412-6 (collectively referred to as pressure signals 412) from pressure sensors 402, generating a compensation factor for wind incident on sensor 202, and providing output signal 210 based on infrasound received by sensor 202.

FIG. 5 depicts a schematic diagram of a pressure sensor in accordance with the illustrative embodiment of the present invention. Each of pressure sensors 402 comprises a pressure port 502 that is fluidically coupled with a displacement sensor 504.

Pressure port 502 is an inlet of suitable size and shape for enabling a pressure at the orifice of the pressure port to induce a pressure signal from its corresponding displacement sensor 504. Pressure ports 502 are separated by a distance of less than a few tens of millimeters, and preferably by a distance of only a few millimeters. In some embodiments, one or more pressure ports 502 include a barrier that deter or prevent entry and/or damage by animals or insects. The size and configuration of pressure port 502 is application dependent and it will be clear to one skilled in the art, after reading this specification, how to specify, make, and use pressure ports 502.

Displacement sensor 504 comprises beam splitter 506, chamber 508, source 512, detector 518, and detector 520. Displacement sensor 504 provides pressure signal 412, which is based on the pressure immediately outside pressure port 502. Pressure signal 412 comprises output signals 522 and 524.

Each of displacement sensors 504 is an optical displacement sensor that has an extremely small footprint. Displacement sensors 504 are analogous to displacement sensors described in U.S. Pat. No. 7,355,723, issued Apr. 8, 2008 (Attorney Docket No.: 123-010US), which is incorporated herein by reference. The small size of displacement sensors 504 enables formation of sensor 202 having a total volume of less than 10 cm³. For example, the size of sensor 202 is approximately 6 mm×6 mm×5 mm.

It is an aspect of the present invention that displacement sensors 504 are characterized by responsivities that are matched within 5% (preferably within a few percent) and are characterized by self-noise that is less than or equal to 1 mPa RMS.

The high-performance characteristics of displacement sensors 504 arise from the performance of beam splitter 506 and the manner in which it is used. Beam splitter 506 is an optically resonant cavity whose cavity length is based on the position of a movable layer. The position of the movable layer is based on the presence and magnitude of a pressure differential across it. The ratio of light reflected and transmitted by the optically resonant cavity is, therefore, based on this pressure differential as well.

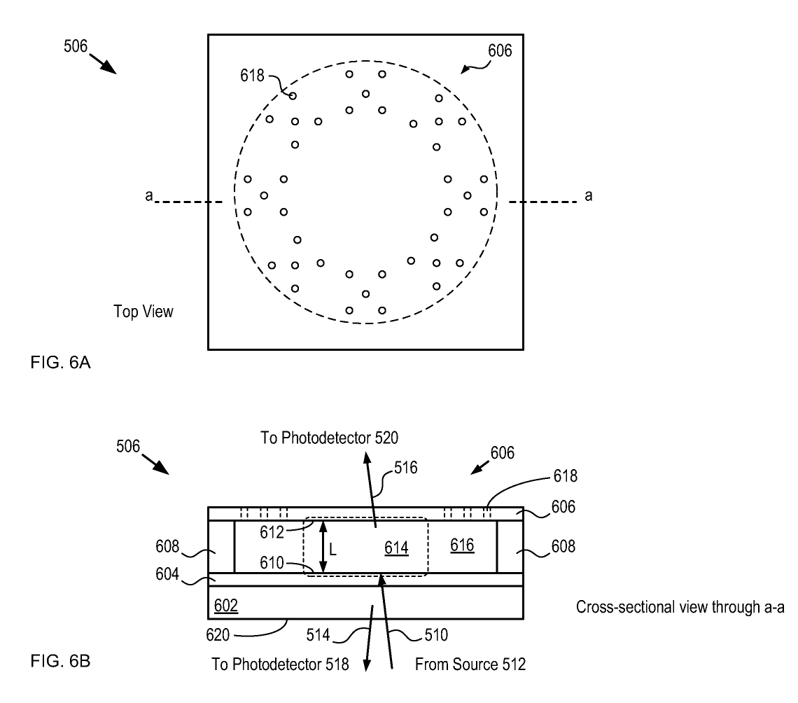

By detecting both the light transmitted by beam splitter and the light reflected by the beam splitter, displacement sensor 504 provides a pressure signal that has very high sensitivity, very high dynamic range, and low self-noise. In some embodiments, detection of only one of the transmitted and reflected light can be used to generate a pressure signal having suitably high sensitivity and dynamic range as well as low self-noise. In some embodiments, beam splitters 506 are fabricated using MEMS-based technology, which facilitates achieving matched responsivities across a number of beam splitters. Beam splitter 506 is described in more detail below and with respect to FIG. 6.

In some embodiments, each of displacement sensors 504 is co-located with its respective pressure port 502. In some embodiments, one or more of displacement sensors 504 is physically displaced from its respective pressure port 502 but fluidically coupled to the pressure port through a conduit.

Source 512 is a laser diode capable of emitting monochromatic light having a wavelength of approximately 1380 nanometers (nm) with a spectral-width of less than ten (10) nanometers, and preferably less than three (3) nanometers. In some embodiments of the present invention, source 512 comprises a light-emitting diode. In still some other embodiments, source 512 comprises a super-luminescent light-emitting diode. In still some other embodiments of the present invention, source 512 comprises a narrow-wavelength-band filter that reduces the spectral bandwidth of source 512.

Detectors 518 and 520 are photodetectors sensitive to the wavelength of the output light from source 512. Detectors 518 and 520 provide output signals 522 and 524, respectively, to processor 406. Output signals 522 and 524 are based on the intensity of reflected beam 514 and transmitted beam 516, respectively. It will be clear to those skilled in the art, after reading this specification, how to make and use detectors 518 and 520.

Although the size of pressure sensor 402 is design dependent and limited only by practical fabrication considerations, one skilled in the art will recognize that pressure sensor 402 will typically have a volume that is within the range of approximately 1 mm³ to approximately 4000 mm³. More particularly, in the illustrative embodiment, pressure sensor 402 is approximately 6 mm×6 mm×5 mm.

FIGS. 6A and 6B depict top and cross-sectional views, respectively, of a beam splitter in accordance with the illustrative embodiment of the present invention. Beam splitter 506 comprises substrate 602, layer 604, layer 606, and spacers 608. Beam splitter 506 receives optical beam 510 from source 512 and splits the optical energy of optical beam 510 into reflected beam 514 and transmitted beam 516. The ratio of optical energy in reflected beam 514 and transmitted beam 516 is dependent upon the characteristics of optically resonant cavity 614, as described below. Optically resonant cavity 614 is formed by surface 610 of layer 604 and surface 612 of layer 606, which are separated by cavity length L.

Substrate 602 is a 500 micron-thick silicon wafer. Substrate 602 provides a mechanical platform for layer 604. Substrate 602 is substantially transparent for the wavelengths of light included in optical beam 510. In some embodiments, substrate 602 comprises a through-hole through which optical beam 510 is directed so as to mitigate absorption of optical energy of optical beam 510 by substrate 602. In some embodiments of the present invention, substrate 602 is a material other than silicon. Suitable materials for substrate 602 include, without limitation, glass, III-V compound semiconductors, II-VI compound semiconductors, ceramics, and germanium. In some embodiments, the thickness of substrate 602 is other than 500 microns.

Each of layers 604 and 606 is a layer of silicon-rich silicon nitride preferably having a thickness substantially equal to n*λ/4, where λ, is the wavelength (within layer 604) of the light in optical beam 510 and n is an odd-integer. Layers 604 and 606 are translucent for optical beam 510. Suitable materials for use in layers 604 and 606 include, without limitation, silicon, glass, silicon dioxide, silicon oxide (SiOx, where x is in the range of 0.1 to 4), titanium nitride, polysilicon, non-stoichiometric silicon nitride (Si₃N₄), stoichiometric silicon nitride (Si₃N₄), III-V compound semiconductors, and II-VI compound semiconductors.

It will be appreciated by those skilled in the art that the distribution of optical energy into the reflected beam and transmitted beam is dependent upon the thickness and index of refraction of each of layers 604 and 606. In addition, it will be appreciated by those skilled in the art that thicknesses of layer 604 other than λ/4 can provide suitable performance, such as any odd-order of λ/4 (e.g., 3λ/4, 5λ/4, etc.). In some embodiments of the present invention, (e.g., wherein a different ratio of transmitted light to reflected light or different mechanical characteristics for one or both of layers 604 and 606 are desired) the thickness of layers 604 and 606 is approximately an even-order of n*λ/4 (e.g., λ/2, λ, 3λ/2, etc.), and n is an even-integer. In still some other embodiments of the present invention, the thickness of layer 604 is made different than any order of n*λ/4.

In some embodiments, at least one of layers 604 and 606 is a glass substrate having a thickness within the range of approximately 1 micron to approximately 200 microns. In such embodiments, surfaces 610 and 612 would comprise a coating having a reflectivity for optical beams 510, 514, and 516 that is within the range of approximately 50% to approximately 85%. Further, the surfaces of layers 604 and 606 distal to surfaces 610 and 612, respectively, would typically comprise an anti-reflection layer.

It should be noted that a thick substrate, such as a 200 micron-thick glass substrate, is suitable for use as layer 606 because such a substrate is typically characterized by little or no tensile stress and thus has higher compliance than many thinner membranes having large tensile stress. Further, infrasound-sensing applications do not require extremely high sensitivity; therefore, a thicker substrate can be used as a deformable membrane than would normally be suitable for a more conventional microphone application.

In some embodiments of the present invention, layer 604 is not present and the optically resonant cavity is formed by a surface of layer 606 and a surface of substrate 602.

Spacers 608 have a thickness of approximately 110 microns. Spacers 608 are formed by etching cavity 616 in a sacrificial layer that interposes layers 604 and 606. The formation of cavity 616 results in suspended membrane 606. The thickness of spacers 608 is determined by the desired performance characteristics of beam splitter 506 for the light in optical beam 510. In some embodiments, spacers 608 are precision spacers interposed between layers 604 and 606 to create cavity 616. Materials suitable for spacers 608 include, without limitation, ceramics, silicon, metals, epoxies, solder, silicon dioxide, glass, alumina, III-V compound semiconductors, and II-VI compound semiconductors. Although the illustrative embodiment comprises spacers that have a thickness of approximately 110 microns, it will be clear to those skilled in the art, after reading this specification, how to make and use alternative embodiments of the present invention that comprises spacers that have a thickness of other than 110 microns.

Surface 610 of layer 604 and surface 612 of layer 606 collectively define optically resonant cavity 614. Optically resonant cavity 614 has cavity-length L. In the absence of a pressure differential across membrane 606, cavity-length L is equal to the thickness of spacers 608. When infrasound energy or a pressure wave due to wind is received at pressure port 502, however, a pressure differential develops across membrane 606 that moves the membrane thereby changing cavity length L. As cavity length L changes, the ratio of optical energy in reflected beam 514 and transmitted beam 516 changes.

Prior-art infrasound sensors are typically based on microbarometers and, as a result, are bulky. The size of the microbarometers has historically been considered an advantage, since the perception has been that large sensors are necessary to reliably measure sound at very low frequencies. In reality, however, the limiting factor for low frequency microphone is the amount of time that it takes to equalize the pressure from the front volume to the back volume.

Holes 618 are included in layer 618 for two primary purposes: (1) they provide access for the etchant used to form cavity 616; and (2) they provide a means of controlling the rate at which air flows into and out of cavity 616 in response to motion of membrane 606. Design considerations for membrane holes are discussed in detail in “Phenomenological model for gas-damping of micromechanical structures,” Greywall, Busch, and Walker, Sensors and Actuators, Vol. 72, pp. 49-70, 1999, which is incorporated by reference herein. Holes 618 are micron-sized holes that are formed in layer 606 by conventional reactive ion etching. In some embodiments, holes 618 are formed using a different suitable technology, such as laser drilling and the like. The presence of holes 618 enables membrane 606 and cavity 616 to be scaled in size to less than a few millimeters, while still providing a time constant for pressure equalization that exceeds that of prior-art microbarometers. One skilled in the art will recognize that the size, number, and positions of holes 618 are matters of design and it will be clear to one skilled in the art, after reading this specification, how to specify, make, and use holes 618.

It should be noted that in some embodiments, as few as one hole 618 is required to achieve a desired performance for sensor 202.

In embodiments wherein substrate 602 comprises a through-hole, the area of layer 604 disposed over the access hole forms a second membrane that enables fluidic coupling between optically active membrane 614 and a larger volume cavity fluidically coupled with beam splitter 506. Such an arrangement enables displacement sensor 504 to be designed with a greater range of time constants.

In some embodiments, an anti-reflection layer for the light in optical beam 510 and reflected beam 514 is disposed on surface 620 of substrate 602.

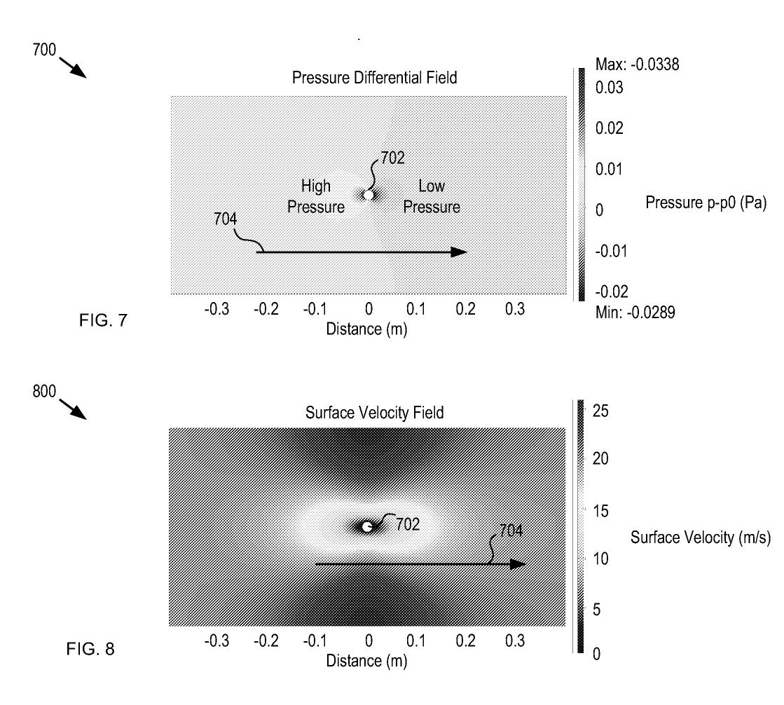

At operation 302, processor 406 generates output signal 210 based on pressure signals 412-1 through 412-6. Since sensor 202 is much smaller than the wavelength of infrasound 208, incident infrasound energy imparts substantially the same pressure on each pressure sensor 402 included in sensor 202. In the absence of wind, therefore, pressure signals 412-1 through 412-6 are substantially equal. Further, as discussed below and with respect to FIGS. 7 and 8, wind flowing across sensor 202 induces a pressure gradient that affects pressure sensors 402 unequally. As a result, in some embodiments, output signal 210 is generated based upon the common-mode characteristics of pressure signals 412-1 through 412-6.

At operation 303, sensor 202 generates a wind-compensation factor based on wind 206.

FIG. 7 depicts a model of pressure versus position for a stationary object subjected to wind. Plot 700 depicts a two-dimensional plot of the relative pressure changes produced around cylinder 702 by a wind blowing across the cylinder. Cylinder 702 is a stationary 2 cm-diameter cylinder positioned within a 20 m/s wind field that is blowing along direction 704 as shown. A wind speed of 20 m/s represents the typical maximum value experienced in most areas of the world. Cylinder 702 approximates sensor 202 as subjected to wind 206. At 20 m/s, the maximum pressure change across sensor 202 due to the wind is approximately 50 mPa.

FIG. 8 depicts the velocity distribution associated with wind incident on a stationary object. Plot 800 depicts the velocity distribution about cylinder 702 assuming Stokes flow and using no-slip boundary conditions. Since cylinder 702 is small relative to the coherence length of the wind vector fields, the simulation disregards the effect of turbulence.

Plots 700 and 800 demonstrate that the effects of wind-induced pressure fluctuations are extremely predictable. In addition, since sensor 202 is much smaller than the wavelength of infrasound, incident infrasound energy imparts substantially identical pressure on each pressure sensor 402. Differences between pressure signals 412, therefore, can be attributed entirely to airflow rather than infrasound energy enabling the effects of wind-induced pressure fluctuations to be directly canceled. Further, using displacement sensors whose responsivities (1) are matched to within a few percent, (2) have high dynamic range as compared to displacement sensors of prior art infrasound sensors, and (3) are characterized by self-noise of 1 mPa or less, embodiments of the present invention can observe wind velocity at the same point that infrasound energy is monitored, obviating the need for widely spaced hose arrays.

In order to generate a wind-compensation factor, processor 406 determines a pressure differential based on at least two of the plurality of pressure signals 412. As evinced by plot 700, wind across an object induces a well-characterized pressure distribution about the object. Specifically, in response to wind 206, a high-pressure region develops on the windward side of sensor 202 while a low-pressure region develops on the leeward side of the sensor. As a result, pressure sensor 402-3 registers an increase in pressure while pressure sensor 402-4 registers a decrease in pressure.

Using the difference between pressure signals 412-3 and 412-4, processor 406 computes the wind-compensation factor for wind 206.

At operation 304, processor 406 generates compensated output signal 210 based on pressure signals 412-1 through 412-6 and the computed wind-compensation factor.

One skilled in the art will recognize that wind across sensor 202 that is not aligned with one of the x-, y-, or z-directions will induce pressure signal differentials across more than one of the pressure sensor pairs aligned with these directions. It will be clear to one skilled in the art, after reading this specification, how to calculate a wind-compensation factor for such cases.

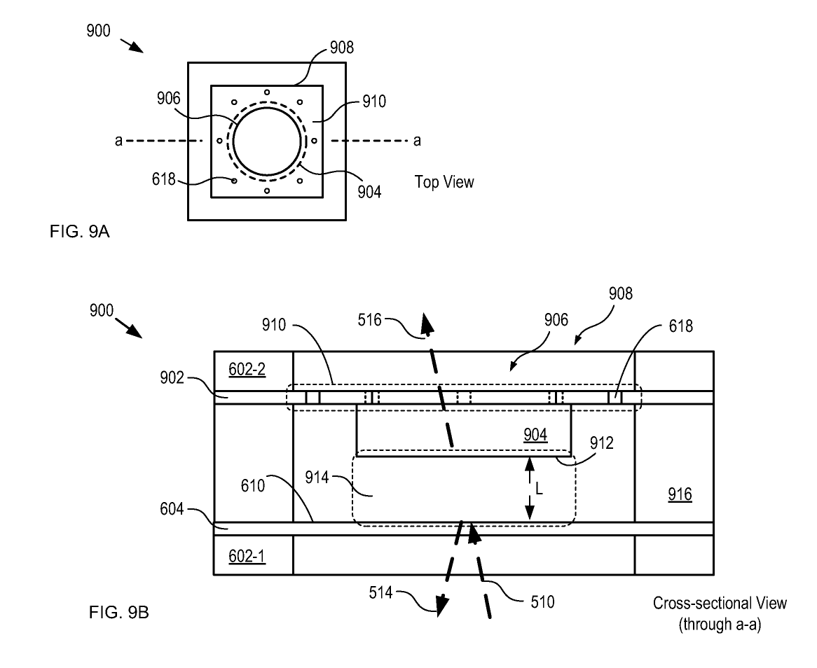

FIGS. 9A and 9B depict top and cross-sectional views, respectively, of a beam splitter in accordance with an alternative embodiment of the present invention. In operation, acceleration sensor 600 is analogous to beam splitter 506.

Beam splitter 900 comprises substrates 602-1 and 602-2, layers 604 and 902, mirror 904, and spacers 916. Beam splitter 900 is analogous to beam splitter 506 described above and with respect FIGS. 6A and 6B.

Layer 902 is a layer of silicon-rich silicon nitride that has been etched to form through-hole 906. Layer 902 is analogous to layer 604.

In some embodiments, layer 902 is a layer of metal that is stamped, cast, etched, or photo-etched to form through-hole 906 and holes 618. In some embodiments, layer 902 comprises a central plate supported from a perimeter region by one or more tethers. In such embodiments, open regions that define the tethers are analogous to holes 618 and contribute to the control of airflow through layer 902.

Layer 902 is disposed on substrate 602-2. Substrate 602-2 comprises through-hole 908. As a result, a portion of layer 902 forms membrane 910, which moves in response a pressure differential across its thickness.

Mirror 904 is a block of material suitable for transmission of light contained in input light signal 510. Although its dimensions are a matter of design choice, an exemplary mirror is a 1 mm by 1 mm square that has a thickness of 0.5 mm. Materials suitable for use in mirror 904 include, without limitation, soda-lime glass, borosilicate glass, fused silica, high-dielectric constant glasses, and the like. In some embodiments, surface 912 is coated to enhance its functionality in optically resonant cavity 914.

Mirror 904 is attached to membrane 910 such that the mirror is aligned with through-hole 906. As a result, light transmitted by optically resonant cavity 914 passes through layer 902 without incurring further reflection or absorption.

Spacers 916 precision spacers that interpose layers 604 and 902 when beam splitter 900 is assembled. Spacers 916, in conjunction with the thickness of mirror 904, define the value of cavity length, L, in the absence of wind and infrasound energy. In some embodiments, substrate 602-2 is not included and layer 610 is disposed on spacers 916.

In similar fashion to the operation of beam splitter 506, beam splitter 900 receives optical beam 510 from source 512 and splits the optical energy of optical beam 510 into reflected beam 514 and transmitted beam 516. The ratio of optical energy in reflected beam 514 and transmitted beam 516 is dependent upon the characteristics of optically resonant cavity 914. Optically resonant cavity 914 is formed by surface 610 of layer 604 and surface 912 of mirror 904, which are separated by cavity length L.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. An apparatus for sensing infrasound energy, wherein the apparatus comprises:
a plurality of pressure sensors symmetrically arranged about an origin, each pressure sensor comprising:
(a) a pressure port; and
(b) a displacement sensor fluidically coupled with the pressure port, the displacement sensor comprising a beam splitter that distributes an input signal into a first signal and a second signal based on a pressure at the pressure port, wherein the displacement sensor is dimensioned and arranged to provide a pressure signal that is based on at least one of the first signal and the second signal;
wherein the responsivity of each of the plurality of pressure sensors is within ±2.5% of the average responsivity of the plurality of pressure sensors.

2. The apparatus of claim 1 further comprising a processor that is dimensioned and arranged to compute an output signal based on the plurality of pressure signals.

3. The apparatus of claim 2 wherein the processor is dimensioned and arranged to compute the output signal based on a common-mode characteristic of the plurality of pressure signals.

4. The apparatus of claim 3 wherein the processor is dimensioned and arranged to generate a wind-compensation factor based on at least two of the plurality of pressure signals, and wherein the processor computes the output signal based on the common-mode characteristic of the plurality of pressure signals and the wind-compensation factor.

5. The apparatus of claim 2 wherein the processor is dimensioned and arranged to generate a wind-compensation factor based on at least two of the plurality of pressure signals, and wherein the processor computes the output signal based on the plurality of pressure signals and the wind-compensation factor.

6. The apparatus of claim 1 further comprising a source of optical energy and an optical splitter that distributes at least a portion of the optical energy into each of the plurality of input signals.

7. The apparatus of claim 1 wherein the pressure signal from each of the plurality of displacement sensors is based on both the first signal and second signal.

8. The apparatus of claim 1 wherein the plurality of pressure ports is arranged in a one-dimensional arrangement about the origin.

9. The apparatus of claim 1 wherein the plurality of pressure ports is arranged in a two-dimensional arrangement about the origin.

10. The apparatus of claim 1 wherein the plurality of pressure ports is arranged in a three-dimensional arrangement about the origin.

11. The apparatus of claim 1 wherein the plurality of pressure ports is arranged such that the pressure ports are equidistance from the origin.

12. The apparatus of claim 1 wherein the plurality of pressure ports is arranged such that the pressure ports are equidistance from one another.

13. The apparatus of claim 1 wherein each of the plurality of displacement sensors is substantially co-located with a different pressure port of the plurality of pressure ports.

14. A method for sensing infrasound, the method comprising:
locating a plurality of pressure sensors at a measurement site, wherein each pressure sensor comprises a pressure port and a beam splitter fluidically coupled with the pressure port, and wherein the plurality of pressure ports are symmetrically arranged about an origin, and wherein each beam splitter distributes an input signal into a first signal and second signal based on a cavity length that is based on the pressure at its respective pressure port, and further wherein the sensitivities of the plurality of beam splitters are matched to within 5%;
providing a pressure signal from each of the plurality of pressure sensors, wherein the pressure signal is based on at least one of the first signal and the second signal from its respective beam splitter; and
generating an output signal based on a characteristic of the plurality of pressure signals.

15. The method of claim 14 wherein the characteristic is a common-mode characteristic of the plurality of pressure signals.

16. The method of claim 14 further comprising:
determining a wind-compensation factor based on at least two of the plurality of pressure signals; and
providing the output signal based on the wind-compensation factor and the plurality of pressure signals.

17. The method of claim 16 wherein the wind-compensation factor is based on a first difference, and wherein the first difference is a difference between a first pressure signal of the first plurality of pressure signals and a second pressure signal of the plurality of pressure signals.

18. The method of claim 17 wherein the wind-compensation factor is based on the first difference and a second difference, and wherein the second difference is a difference between a third pressure signal of the plurality of pressure signals and a fourth pressure signal of the plurality of pressure signals.

19. The method of claim 16 wherein the second output signal is based on the wind-compensation factor and a common-mode characteristic of the plurality of pressure signals.

20. The method of claim 16 further comprising arranging the plurality of pressure sensors within a volume that is less than or equal to ten cubic centimeters.
